(19) United States
(12) Patent Application Publication
(10) Pub. No.: US 2008/0177762 A1
(43) Pub. Date: Jul. 24, 2008

(54) Method and System Using a Cookie Code For Distributing Infomation Related to Internet Users

(75) Inventor: Sunny Paris, Paris (FR)

Correspondence Address: PAULEY PETERSEN & ERICKSON, 2800 WEST HIGGINS ROAD, SUITE 365, HOFFMAN ESTATES, IL, 60195, US

(73) Assignee: Weborama, Paris (FR)

(21) Appl. No.: 11/663,291

(22) PCT Filed: Sep. 20, 2005
(86) PCT No.: PCT/EP05/54712

§ 371 Date: Oct. 17, 2007

(30) Foreign Application Priority Data
Sep. 20, 2004 (FR) 0409916

(51) Int. Cl. G06F 17/30

(52) U.S. Cl. 707/100; 707/E17.009

(57) ABSTRACT

A method for storing navigation information of a set of users of a communication network on a set of internet sites accessible through the network in storage resources connected thereto consisting, for each site of the set of internet sites, in transmitting navigation information of a user connecting to said site by the storage resources. The navigation information comprises a single user's identifier that includes a plurality of characters which are recorded in a cookie installed in the user's navigation station. The method involves storing the navigation information of the user in a database of a set, forming the storage resources of the databases distinctive from each other and selecting the database according to a value of a given character of the user identifier.

### BACKGROUND OF THE INVENTION

### Field of the Invention

The invention concerns a method and a system used to efficiently store information relating to the navigation of a large number of users in a communication network and in particular with a view to subsequent accessing or processing.

The invention will be particularly useful for the compilation of behavioral profiles of Internet users or those of any other communication network, as well as for the display of digital advertising messages as a function in particular of the historical record of previously viewed messages.

The Internet network is an open network in which a very large number of users are active. In order to display the right message to the right person at a given moment, it is very important to be able to access information concerning this user in a very short time.

This information can be a pre-compiled profile, a complete historical navigation record over a collection of sites of interest or a list of advertising messages already viewed by the user.

The present invention proposes a solution that allows the management of a very large number of users (several billion for example), in a simple manner.

When a user connects successively to a series of Web sites of interest, or when a user is exposed to an advertising message, it triggers the successive transmission of queries to a system such as a behavioral profiling system for example, or an audience measuring system, or even an advertisement broadcasting system.

These queries are then interpreted by the system as the provision of navigating information.

This navigating information typically includes the identifier of the user, the identifier of the site or of the advertising message, the date, the time, the language of the Internet user, and the part of the site actually visited.

The identifier of the user is generally a unique identifier recorded in a cookie (or connection record) installed on the navigation station of the user.

For example, this cookie is installed on the navigation station of the user (with a unique identifier then being assigned to the user) during the first visit by the latter to one of the sites of interest.

The navigation information is typically recorded by the profiling system in storage resources or databases, and constitutes the historical navigation record of the user to be identified.

It is from this historical record in particular that the profiling system is able to determine a statistical profile of the user.

The data stream collected by the profiling or advertisement broadcasting system (i.e., navigation information on the Internet users) is particularly important. By way of an example, when about 20,000 French-language sites of interest are thus audited, more than 10 gigabytes of navigation information are collected each day. Moreover, this mass of information is constantly growing.

A profiling or distribution system of the type presented above must be able to satisfy a number of constraints. In particular, it must be capable of covering a large audience of Internet users, in order to be able to react in real time to send the profile of a user to a site asking for it, and it must be extremely stable.

This means that the computer resources used (in particular storage resources and servers for processing the navigation information) must be designed to access the stored information, to process it and to return it in a minimum amount of time, while also ensuring continuity of the service provided by the profiling or distribution system.

It is currently considered that such a system is inoperative if the profile of a user is returned to a Web server after an excessive wait.

It is also considered that all technical failure must be avoided. Interruption of the service (that is when a user profile is not returned to a Web server following a query from the latter) provided by the profiling system currently has legal consequences for the service provider hosting the Web site. The latter is thus unable to dynamically adapt the digital content that it is offering as a function of the profile of each user, and to thereby optimize its efficiency.

There is therefore a need for a solution that can be used to manage the navigation information of a number of different users of a particularly large communication network, and that satisfies the aforementioned constraints.

### SUMMARY OF THE INVENTION

To this end, according to a first aspect, the invention proposes a method for the storage of navigation information for a collection of users in a communication network over a collection of sites of interest that are accessible via the network, in storage resources that are connected to the network, including a stage that comprises or consists, for each site of the collection of sites of interest, of transmitting to the storage resources the navigation information of a user connecting to the site, where the navigation information includes a unique identifier of the user composed of a multiplicity of characters, recorded in a cookie that is installed on the navigation station of the user, the method being characterized in that it includes a stage comprising or consisting of storing the navigation information of the user in a database of a collection, forming the storage resources, of databases that are separate from each other, with the choice of database being effected as a function of the value of a given character of the identifier of the user.

Preferred but not limiting aspects of the method according to the first aspect of the invention are as follows:

the choice of the database can be effected as a function of a given character of the identifier, such that the distribution of the users is homogeneous for all of the values that this character can take;

the storage stage can comprise or consist moreover, for each database, of storing the navigation information of the user in a data table of a collection, forming the database, of data tables that are separate from each other, with the choice of the data table being effected as a function of the value of a second given character of the identifier of the user;

the choice of the data table can be effected as a function of a second given character of the identifier such that the distribution of the users is homogeneous for all of the values that this character can take;

the storage stage can moreover comprise or consist of storing the navigation information of a user in at least one computer device, with each device hosting a collection of databases forming storage resources, with the choice of device being effected as a function of the value of a third given character of the user's identifier;

the choice of the device can be effected as a function of a character of the identifier so that the distribution of the users is homogeneous for all of the values that this character can take;

the navigation information of the user can be stored in a data table of a database hosted by a device, with the choice of the device, base and table being effected as a function of the first three characters of the identifier, with the identifier having twelve characters according to a base 64 number system.

According to a second aspect, the invention proposes a system for the storage of navigation information for a collection of users in a communication network over a collection of sites of interest that are accessible via the network. The system includes storage resources connected to the network in order to store the navigation information transmitted by each site of the collection of sites of interest when a user connects to the site, where the navigation information includes a unique identifier of the user composed of a multiplicity of characters, recorded in a cookie installed on the navigation station of the user. The storage resources are composed of a collection of databases that are separate from each other, with the choice of a database for the storage of the navigation information relating to a user being effected as a function of the value of a given character of the identifier of the user.

### BRIEF DESCRIPTION OF THE DRAWING

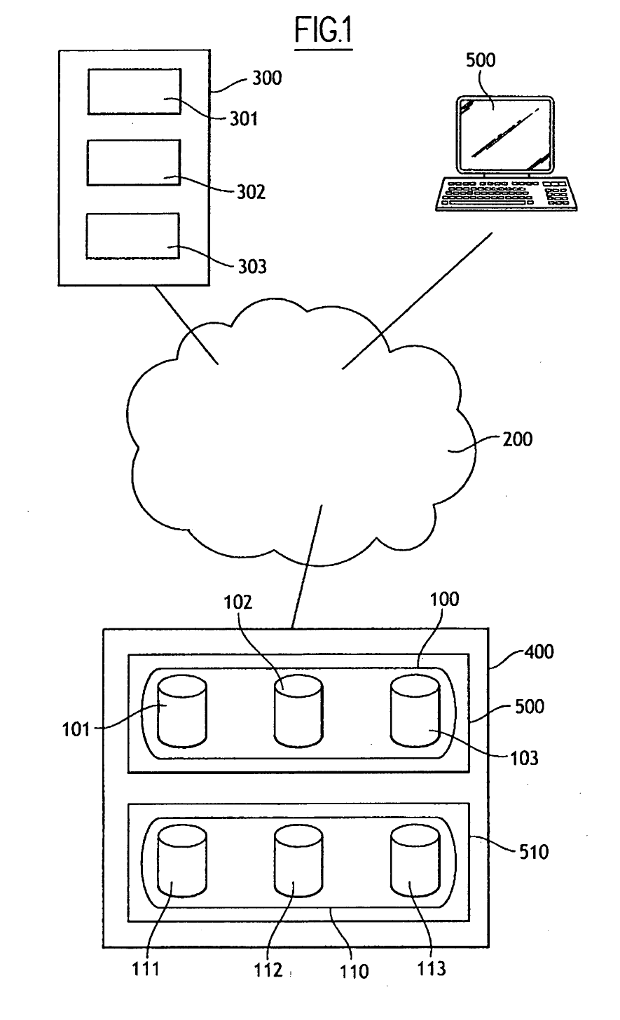

Other characteristics, aims and advantages of the invention will emerge from the description that follows of one possible method of implementation of the invention, this description being purely illustrative and non-limiting, and which should be read with reference to the single appended FIG. 1. FIG. 1 is a representative diagram of a system for the storage of navigation information according to one possible method of implementation of the invention.

### DETAILED DESCRIPTION OF THE INVENTION

In the figure, a profile determination system 400 is connected to a communication network 200 (such as the Internet) to which a collection 300 of Web servers of interest 301, 302, 303 is connected.

Each Web server is hosting a site or digital content that is placed at the disposal of the users 500 of the network 200 (the Internet users) by a service provider.

The profile determination system 400 includes storage resources 100, 110 connected to the network 200, and designed to collect information relating to the navigation of the internet users 500 in the sites hosted by the Web servers 301, 302, 303.

As mentioned previously, this navigating information is transmitted as a result of a profile query emitted by a Web server of interest 301 and addressed to the profiling system during the visit of a user to the site.

This navigating information typically includes the identifier of the user, the identifier of the site, the date, the time, the language of the Internet user, and the part of the site actually visited.

The identifier of the user is generally a unique identifier recorded in a cookie (or connection record) installed on the navigation station of the user.

This cookie is installed, for example, on the navigation station of the user (a unique identifier then being assigned to the user) during the first visit by the latter to one of the sites of interest.

The unique identifier associated with a user is composed of a multiplicity of characters, with each character able to take a certain number of different values, as a function of the base of the selected number system.

According to one method of implementation of the invention, the identifier has twelve characters, according, for example, to a base 64 number system. Each character can thus take 64 different values.

According to one preferred method of implementation of the invention, the navigation information is distributed in a collection, forming the storage resources 100, of databases 101-103 that are separate from each other, with each database 101-103 storing the navigation information relating to the users having an identifier presenting a given identical character from amongst the multiplicity of characters, or a given character taking a value from amongst a collection of values.

In other words, in a given database Bₖ, there is stored only the navigation information relating to the internet users whose i-th character (i.e., the given character) of the identifier has the same value Cₖ, or whose i-th character has a value from among a collection {C}ₖ of values.

Preferably, this given character is a character such that the distribution of the Internet users is homogeneous (due to a random draw for example) for all of the values that this character can take. The probability that this given character of the identifier of a user has a particular value is thus the same, whatever the particular value.

To this end, use is advantageously made of the manner in which the identifier assigned to a user is determined. In the context of an identifier with twelve characters, it is possible to achieve a homogeneous distribution of the users on certain characters, and on the first and second characters for example.

As is customary, the other characters of the identifier contain elements that are necessary to ensure, preferably alone, the uniqueness of the identifier. As an example, this comprises or consists of the date, the time in seconds, the IP address of the server establishing the identifier, the PIN (Process Identification Number) of the process establishing the identifier, an incremental number, etc.

In the instance of a homogeneous distribution, and considering a base N number system, the internet users are thus distributed, as a function of the value taken by the given character of their identifier, in N groups of identical size. The navigation information is therefore stored, in a homogeneous and particularly simple manner, in N separate databases.

According to one advantageous method of implementation of the invention, each of the databases 101-103; 111-113 is composed of a collection of data tables that are separate from each other.

The navigation information is then distributed so that each data table stores the navigation information relating to the users having an identifier presenting a second given identical character from among the multiplicity of characters or a second given character with a value from among a collection of values.

In other words, in a given data table Tₚ, belonging to a database Bₖ, is stored only the navigation information relating to the internet users whose i-th character (i.e., the first given character) of the identifier has the same value Cₖ (or at least takes a value from among a collection of values {C}ₖ) and whose j-th character (i.e., the second given character) has the same value Cₚ (or at least takes a value from among a collection of values {C}ₚ).

Preferably, this second given character is also a character such that the distribution of the Internet users is homogeneous (due to an obligatory draw) for all of the values that this character can take. In such circumstances, and considering a number system in base N, the internet users are thus distributed, as a function of the value taken by the given first and second characters of their identifier, in N*N groups of identical size. The navigation information is therefore stored, in a homogeneous and particularly simple manner, in N*N separate data tables.

As mentioned previously, in the case of an identifier with twelve characters, a homogeneous distribution of the users on the first and the second characters of the identifier is obtained. According to one possible method of implementation of the invention, the given first and second characters (associated respectively with the distribution in bases and the distribution in data tables) are respectively the first and the second characters of the identifier.

According to one alternative method of implementation of the invention, the storage system includes a multiplicity of storage resources 100, 110 of the type presented previously.

To this end, the databases are hosted by several separate computer devices, where each computer device has resources that are designed to host a collection forming storage resources in the sense of this invention.

In other words each device is hosting a collection of databases that are separate from each other, with each database storing the navigation information relating to the users having an identifier presenting a given identical character from among the multiplicity of characters (or a given character taking a value from among a collection of values).

Referring to FIG. 1, a computer device 500 is hosting the storage resources 100 composed of databases 101-103, while a device 510 is hosting the storage resources 110 composed of databases 111-113.

In such circumstances, the navigation information is then distributed so that each device stores the navigation information relating to the users having an identifier presenting a third given identical character from among the multiplicity of characters (or indeed a third given character with a value from among a collection of values).

The internet users are then distributed in the databases as a function of the first given character of their identifier (the second character of the identifier for example), as well as, where appropriate, in the data tables constituting a database as a function of the second given character of their identifier (the third character of the identifier for example).

According to one possible method of implementation, the third given character (for a distribution between devices) is a character of the identifier, such as a character in the header of the identifier for example. Thus in the aforementioned case of an identifier with twelve characters, a thirteenth character can be added in the header of the twelve others to allow the distribution between the different computer devices.

By way of an illustrative example, the information concerning the user having the SuNXXXXXXXXXX identifier can thus be stored in device S, in base u, in table N.

Considering a base N number system, if the internet users are distributed on different hosting devices, it is therefore finally possible to distribute them in up to N*N*N groups.

By using a single computer device, and in the context of a base 64 number system, the navigation information relating to the internet users visiting one of the sites of interest are thus distributed in 64 separate databases, with each of these bases having 64 data tables.

In this circumstance, the navigation information is distributed in 4096 separate data tables, as a function of the values taken by the given first and second characters of the user's identifier.

As has been mentioned previously, the navigation information available for a given user is, for example, intended to be processed by a profiling system, in order to determine and update the profile of the user.

The profile thus determined is stored in the storage resources according to the distribution by user presented above.

The system presented here of storage resources by distribution of the Internet users in separate data structures (computer devices, bases, tables, etc.) is therefore particularly interesting. In particular, it provides rapid access to the navigation information and to the profile data, and allows parallel processing of the different data structures.

Naturally, the invention is not limited to the particular methods of implementation described above, but extends to any variant that conforms to its spirit. It will be appreciated in particular that the use of the invention is not limited to the context of a profiling method and system. In fact, the invention can be applied anyplace where information relating to users of a communication network, having an identifier with a multiplicity of characters, has to be stored and processed.

In particular, the invention can also be used for systems that have advertising content servers on the Internet for which access to the profile and/or to the historical record of the user is very important. Likewise, the distribution of the Internet users proposed by the invention allows the execution of a very simple and effective sampling process with a view to predictive calculation or simulations.

By extension, the invention can also be applied in any system required to process the data of a very large number of identifiable objects, independently of each other. The distribution of the navigation information effected by the invention can also be used for very rapid retrieval of information on an identified object from among a very large number of objects, without the need to emit a necessarily lengthy query, in a data “megabase”.

1. A method for the storage of navigation information for a collection of users in a communication network over a collection of sites of interest that are accessible via the network, in storage resources connected to the network, including a stage that comprises, for each site of the collection of sites of interest, of transmitting to the storage resources the navigation information of a user connecting to the site, with the navigation information having a unique identifier of the user, comprising a multiplicity of characters, recorded in a cookie installed on a navigation station of the user, the method comprising a stage of storing the navigation information of the user in a database of a collection, forming the storage resources, of databases that are separate from each other, with choice of database being effected as a function of a value of a given character of the identifier of the user.

2. A method according to claim 1, wherein the choice of the database is effected as a function of a given character of the identifier, so that the distribution of the users is homogeneous for all values that the character can take.

3. A method according to claim 1, wherein the storage stage also comprises, for each database, storing the navigation information of the user in a data table of a collection, forming the database, of data tables that are separate from each other, with the choice of the data table being effected as a function of a value of a second given character of the identifier of the user.

4. A method according to claim 3, wherein the choice of the data table is effected as a function of a second given character of the identifier so that the distribution of the users is homogeneous for all values that the second given character can take.

5. A method according to claim 1, wherein the storage stage also comprises storing the navigation information of a user in at least one computer device, with each device hosting a collection of databases forming storage resources, with the choice of a device being effected as a function of a value of a third given character of the user's identifier.

6. A method according to claim 5, wherein the choice of the device is effected as a function of a character of the identifier so that the distribution of the users is homogeneous for all values the character can take.

7. A method according to claim 6, wherein the navigation information of the user is stored in a data table of a database hosted by a device, with the choice of the device, base and table being effected as a function of the first three characters of the identifier, the identifier having twelve characters according to a base 64 number system.

8. A system for the storage of navigation information for a collection of users in a communication network over a collection of sites of interest that are accessible via the network, the system having storage resources connected to the network to store the navigation information transmitted, by each site of the collection of sites of interest, when a user connects to the site, where the navigation information includes a unique identifier of the user, composed of a multiplicity of characters, recorded in a cookie installed on a navigation station of the user, wherein the storage resources comprise a collection of databases separate from each other, with the choice of a database for the storage of the navigation information relating to a user being effected as a function of a value of a given character of the identifier of the user.

9. A system according to claim 8, wherein each of the databases is composed of a collection of data tables, with the choice of a data table for the storage of the navigation information relating to a user being effected as a function of a value of a second given character of the identifier of the user.

10. A system according to claim 8, comprising at least one computer device hosting a collection of databases forming storage resources, with the choice of a device being effected as a function of a value of a third given character of the user's identifier.
